(19) United States
(12) Patent Application Publication
(10) Pub. No.: US 2004/0204988 A1
(43) Pub. Date: Oct. 14, 2004

(54) Interactively communicating selectively targeted information with consumers over the internet

(76) Inventors: Howard Francis Willers, Santa Clara, CA (US); Frederick John Weiss, Pasadena, CA (US); Phillip Thomas Weiss, Pasadena, CA (US)

Correspondence Address: HOWARD E LEBOWITZ, 19682 HESPERIAN BLVD, Suite 208, HAYWARD, CA, 94541, US

(21) Appl. No.: 09/991,512

(22) Filed: Nov. 16, 2001

(51) Int. Cl. G06F 17/60

(52) U.S. Cl. 705/14; 715/517

(57) ABSTRACT

The invention pertains to a message, system and software allowing permissive interactive marketing among a plurality of users and a plurality of sponsors over a computer network such as the Internet. The system provides users with a desktop portal which comprises valuable utilitarian software to promote use of the portal and a message receiving space. The portal is customizable such that each sponsor can present a unique look and feel while at the same time providing users with a familiar functionality. By selection of sponsors each user forms a virtual dynamically variable network corresponding to his preferences.

### BACKGROUND OF THE INVENTION

1. Field of the Invention

The field of the invention includes methods, systems and software for interactively communicating promotional information over a computer network such as the Internet.

2. Description of the Prior Art

There has been an explosion of use of the Internet by consumers. There are a number of business models which have become ubiquitous for providing promotional information such as sales and marketing information over the Internet. The available methods have their advantages but each has disadvantages as well.

One popular method of providing information to consumers is by sending e-mail messages. Various sponsors send e-mail messages to current or potential customer's e-mail accounts. The sponsor obtains e-mail addresses through various methods and sends out messages which can evoke a response e-mail or contain a link to a world wide web site where the consumer can obtain more information. E-mail has many advantages, in that it has a very low cost per message to send and it follows the direct mail marketing model which has been used for many years. It has the advantage, like its direct mail predecessor, of being able to target a message with at least some degree of precision to users with an interest in the subject matter by choice of mailing list. However, over a relatively short period of time Internet user consumers have become inundated by e-mail promotional materials. This has led to a very low effectiveness factor for commercial e-mail. Many consumers limit which e-mails they open to predetermined senders and use various schemes to filter the flood of promotional e-mail without seeing the contents. The future of ordinary e-mail for advertising and marketing is likely to become less valuable in the future.

Another popular method of providing sales and marketing information to consumers is providing static or dynamic advertisements on a world wide web page where other valuable services are made available to attract users. A common method is to provide a useful web site such as a search engine portal or other useful site which provides access to useful information and services. Either static advertisements or dynamically variable banner ads are provided on the site which provide a brief advertisement or other message and a link to another web site when the static ad or banner is clicked upon. Some such sites contain a further improvement whereby the advertisement which is displayed is customized depending on the various interests displayed by the consumer while on the site, for instance what information is accessed. The web site advertisement method has the advantage of following a model similar to that of commercial television, where advertisers pay for content. While this approach has been quite successful it has a number of disadvantages. One disadvantage is that in spite of improvements of the model to provide some degree of customization of the message to the interests of a particular user, there is no good way to target a message with specificity to users who have an interest in the subject matter of the message. As a result, users are subjected to a wide range of advertising of which only a very small proportion is relevant. Banner ads slow down performance of a site as they refresh and irrelevant ads generally deteriorate the user's experience and develop consumer resistance rather than loyalty. Banner ads are not an example of “permissive interactive marketing”.

Another variation on the web site advertising is to provide a valuable service such as facsimile delivery or e-mail delivery without charge or at reduced charge in exchange for placing advertising on the messages. This technique has the same advantages and disadvantages as the web site advertising method.

All of the above Internet advertising options also have a disadvantage that they are only available to a user while accessing the Internet, e-mail or the world wide web. Much of a computer user's time is spent on other activities such as word processing or games and the existing methods do not take advantage of this “off line” time.

There is a need for an improved method of communicating advertising and promotional messages to consumer users over computer networks such as the Internet.

There is a need for an improved method and system for communicating advertising and promotional information to consumers over computer networks such as the Internet which can be targeted selectively to consumers who have an interest receiving information of the type offered and which promotes consumer loyalty.

There is a need for an improved method and system for communicating advertising and promotional messages from sponsors to consumers which is capable of delivering its message with a common interface which can be used by many sponsors but which is at the same time customized to each sponsor to promote consumer loyalty.

### SUMMARY OF THE INVENTION

The instant invention comprises methods, software and systems for providing advertising, marketing and promotional information to users over a computer network such as the Internet in such a way that the message is targeted to consumers having an interest in the subject matter of the information and which promotes user loyalty.

The methods, software and systems according to the instant invention involve selectively communicating promotional information such as advertisements, marketing information, common information for an organization, or affinity group or the like, generally any sort of communication that would be appropriate between a sponsoring business or organization and a plurality of users. In this context, users refers generally to the consumers of a business or members of an organization who use a computer which has an operating system with a graphical user interface (GUI) and has access to a computer network such as the public Internet. Operating systems include systems such as Microsoft Windows™, Linux, Apple OS and Solaris™. Such operating systems generally have a task bar which displays status information, launches applications and provides other services. Task bars are generally at the bottom of the desktop, but usually may be located elsewhere by default and relocated by the user.

The embodiments of the invention include a client software which installs a portal, known as a value portal, on the user's computer system. The value portal occupies an elongated strip occupying one and preferably two lines on the operating system GUI or the GUI of an application program and comprises a message viewing area, functional buttons for launching application programs and network links, and ornamental features. The preferable position for installing the value portal is overlaying the operating system task bar, preferably at the bottom of the GUI desktop. This location has been determined to be the optimal focus of a user's attention. An alternative is just adjacent to the operating system task bar, just above the task bar in the case of a task bar at the bottom of the GUI. Still another alternative involves the client software launching a ubiquitous application program such as a personal information manager and positioning the value portal thereon. The value portal includes a viewing area for displaying messages. The value portal provides the user with access to valuable additional software applications and network links and is functional whether or not the user is connected to the network, though the network links will only be functional when the user is connected to the network. The additional software applications include applications such as office software, preferably comprising word processing, spreadsheet applications and presentation applications, a personal information manager, e-mail application, multi-media player, and the like which are likely to be used routinely by the users and promote reliance of the user on the applications. Access to the additional software applications is preferably limited to access through the value portal, to promote regular use of the value portal. A preferable feature of the client software is to coordinate the position of items on the desktop, so that when successive applications are launched, the applications resize so as to dock with each other rather than to launch a new application overlapping or covering another existing application. A major purpose of the additional software is to provide value to the user, and reliance on the value portal in day to day use of the computer.

The value portal has a look and feel which includes variable features which are determined by a group of customization parameters. The variable features include appearance features such as color and designs, and certain links to network sites of interest to a class of users. There are preferably other invariant links which are not changed by changes in the customization parameters. The additional software applications are also preferably not changed in functionality by changes to the customization parameters. Therefore a value portal includes variable features which depend on the customization parameters and invariant features which are invariant to changes in customization parameters. Each group of customization factors which defines a unique look and feel is known as a “skin”. The client software further comprises a system database capable of holding a plurality of groups of customization parameters, each corresponding to a different look and feel of the value portal. The variable features associated with a look and feel serve to promote unity or brand loyalty with the users which have installed the skin and the sponsor associated with a look and feel skin.

The client software also includes functionality which provides a user's computer with the ability to communicate with at least one sponsor server operating a sponsor server software according to a special communications protocol, to send and receive messages from the sponsor server, and to display messages received on the viewing area of the value portal. The communication provided between the client software and the at least one message server according to the special communications protocol preferably also includes the ability to check and update the client software and update the system database, and preferably to authenticate the user to the message server and to receive authentication of the message server.

When the invention is implemented as a system each sponsor will preferably communicate through at least one sponsor server operating the sponsor's server software. A sponsor may communicate through more than one server and more than one sponsor may communicate through one server. According to the preferred embodiment, the client software provides the capability to cycle through the sponsors which have a skin installed on the system database and to choose a subset of sponsors with which to communicate, according to user preference. Preferably the client software, special communications protocol, and server software enable a first user to send and receive messages to a second user through any sponsor server which both users access as described above.

One embodiment of the invention is a method for providing a system for communicating promotional information among a plurality of sponsors and a plurality of users over a computer network such as the Internet. The method includes the acts of:

1. enrolling a plurality of sponsors, the act of enrolling comprising assigning each sponsor with at least one group of customization parameters defining a unique skin for a value portal;

2. providing sponsor server software in computer useable form to at least one sponsor;

3. making the client software program available to a plurality of users to install on their computers with at least one group of customization parameters installed in the client software database; and

4. preferably, providing at least one authentication server on the computer network such as the Internet, wherein the at least one authentication server includes authentication server software executing thereon which allows a user's computer operating the client software to authenticate with a sponsor server operating the sponsor server to authenticate to each other.

In a preferred embodiment of the invention, the client software program is initially made available to users by sponsors, for example on promotional CD-ROM distributions or by downloading from a web site, though the software can also be centrally distributed. The initial program contains the invariant portion of the client software and at least one group of customization parameters which defines a skin, which are unique to the sponsor making the distribution.

The group of customization parameters which determine a particular skin is uniquely assigned to one sponsor. A sponsor may have more than one skin, or variants of a skin to provide additional customization depending on user characteristics. For instance since a skin comprises both appearance features and network links, one sponsor may wish to provide a number of different skins with a common appearance but different links.

After a user installs the client program customized for the first sponsor, it is only necessary to add additional groups of customization parameters to a user's system database to make value portals available on a user's computer which are customized with the unique skins of different sponsors. Also it is only necessary to change the parameters within a particular group of customization parameters to change an existing skin. The system employing the invention thus provides a carefully controlled “mass customization” which allows users to have a comfortable common value portal interface on their desktop which is capable of providing a unique and individually customized look and feel to a wide variety of sponsors.

Sponsors may advantageously distribute the client software including their own skin's group of customization parameters in the system database distributed to potential users, along with those of other sponsors. When users install the software on their computer, they will preferably be given the choice of which skins to install in addition the distributing sponsor skin. Additional skins of other sponsors may be made available to existing users by providing a relatively small file of the customization parameters for installation in the system database. An advantageous method of making new skins of additional sponsors available to users is to establish a world wide web site where different groups of customization parameters are placed for downloading as new sponsors are enrolled.

In a preferred embodiment the at least one sponsor server comprises a plurality of sponsor servers, each operated by a sponsor. In one variation, each sponsor has a separate message server, while in a second variation one server is the sponsor server for a plurality of sponsors. Where there are multiple servers it is also desirable to provide at least one authentication server for authenticating a client and a message server during a communication according to the protocol.

There is functionality in the client software program to make the identity of the user known to the sponsors whose skins are made available and to the communications server to facilitate future communications when a user installs the client software program on a computer or adds a new group of customization parameters corresponding to a new skin to the database. Preferably, demographic data about the user is also solicited.

The communications protocol preferably contains provisions for authentication of the client and the at least one message server, checking for updates to the client software or customization parameters, and passing messages to and from the message server.

The client software has functionality to operate the user's computer to check the appropriate message servers periodically, download messages and display them on the value portal as appropriate. It will be apparent that there are many possible ways to configure the client server to check for and display messages. A preferred way is to check the servers and display messages from the sponsor whose skin is currently active, and from the first skin which was loaded if different from the currently displayed skin. Optionally, message servers can be checked for each sponsor with a skin defined in the system database. An alert notice may be displayed showing that there are additional messages waiting from other sponsors. An advantageous option allows the users to choose which sponsors' messages are to be displayed at any time.

A system for selective communications of promotional information among a plurality of sponsors and users over a computer network comprises:

1. at least one sponsor server accessible over the computer network;

2. a plurality of user's computers each having access to the computer network, with an operating system having a GUI;

3. client software operating on each of said plurality of users' computer;

4. sponsor server software operating on each of the at least one sponsor server; and

5. a communications protocol allowing communication between the at least one message server and each of said plurality of users computers.

The system for selective communications as above preferably further comprises at least one authentication server accessible over the computer network which is capable of authenticating a user and a sponsor server communicating according to the protocol.

A system according to the invention solves many of the problems from the prior art. A value portal interface is provided which can have nearly universal utility to the user engaged in a computer activity. The value portal has a common message protocol so that the system can be used by many sponsors. At the same time the interface is customized to each sponsor, both with respect to appearance, and also to providing network links which are particularly relevant to the sponsor.

An important feature of the invention is that users can choose which sponsors' value portal skins to install and which sponsors to receive messages from. The set of installed groups of customization parameters each of which determines a sponsor's skin becomes a dynamically changeable association of interests that the user is receptive to information about. When the user's client software is configured to periodically cycle between the sponsor servers corresponding to sponsors whose skins are installed on the user's computer looking for messages, a network is formed constituting the user, his sponsors of interest, and other users who share a sponsor in common. The system thus practices a form of permissive interactive marketing which fosters the user's loyalty to the sponsors.

It is an object of the invention to provide a method and system to provide permissive interactive marketing among a plurality of sponsors and consumers with communication over a computer network such as the Internet.

It is an object of the invention to provide a method and system to provide permissive interactive marketing among a plurality of sponsors and consumers with communication over a computer network such as the Internet which provides a common format for communication which can be customized by each sponsor.

It is an object of the invention to provide a method and system to provide permissive interactive marketing among a plurality of sponsors and consumers with communication over a computer network such as the Internet which will encourage use by consumers both while connected to the network and while disconnected.

### BRIEF DESCRIPTION OF THE FIGURES

These and other features, aspects and advantages of the present invention will become better understood with regard to the following description, appended claims and accompanying drawings, where:

FIG. 1 is an image of a value portal.

FIG. 2A-2F are charts showing tables of customization parameters used to specify the look and feel of a value portal skin.

FIG. 3 is a drawing showing sponsor-user communication over the Internet using the special communications protocol.

FIG. 4 is a drawing showing the types of information exchanged between sponsor and users.

FIG. 5 is a flow diagram of the communication sequence according to the special communications protocol.

FIG. 6 is a drawing showing the relationship of the Client Software components.

FIG. 7 is a high level flow sheet of the Client Software logic.

FIG. 8 is a flow sheet of system processing in the Client software.

FIG. 9 is a flow sheet showing display events in the Client Software.

FIG. 10 is a flow sheet showing the check for event routine in the Client Software.

FIG. 11 is a flow sheet showing the Initiate Remote Events Routine.

FIG. 12 is a flow sheet showing handling of Operating System Events.

FIG. 13 is a flow sheet showing handling of Button Events.

FIG. 14 is a flow sheet showing handling of keyboard commands.

FIG. 15 is a flow sheet showing handling of Display Events.

FIG. 16 is a block diagram of the sponsor server.

FIG. 17 is a diagram showing the Protocol Layers and communications components of the special communications protocol.

FIG. 18 is a time sequence of the typical authentication process.

FIG. 19 is a time sequence of the authentication process when the authorization server is not available.

FIG. 20 is a time sequence of the authentication process when multiple updates are required.

FIG. 21 is a time sequence of the authentication process for server to server authentication.

FIG. 22 is a drawing of a virtual network formed by a user of the system.

FIG. 23A is a drawing of the client software on a CD ROM.

FIG. 23B is a drawing of sponsor server software on a CD ROM.

### DETAILED DESCRIPTION

Overview of the Method and System

The invention provides methods, systems and software to enable selective communication of marketing, promotional, and information between a plurality of sponsors and a plurality of users involving use of a computer network such as the Internet. The method involves a new paradigm of online marketing which achieves a result known as permissive interactive marketing.

Almost all mass marketing includes some version of the model where a seller give some form of value to a potential consumer in return for the consumer considering the seller's message. On radio and television the programming content is provided in return for advertisements interspersed among the contents. Internet banner advertising attempts to follow this model by providing useful information on a site to attract users while providing advertisements on the site onto which an interested user can click. Some degree of selectivity is possible in these direct advertisement models, such as choosing a web page content which attracts a particular type of user, such as by providing specialized content such as historical content or scientific content. However, the selection process has a high randomness factor and media marketing tends to work best where the market and hence the message is broadest. In online advertising, as in its television/radio counterpart, advertising is considered by viewers at best as a “necessary evil” and at worst as breeding resentment. Also, access to web banner advertising is limited to the time a consumer is using a particular site, a small part of a user's total computing time.

The instant invention provides users with value in a different manner than the conventional models and provides the freedom for users to choose which sponsors' marketing messages they will view and to readily communicate with the chosen sponsors. The nature of the platform promotes continuous, long term, voluntary usage of the platform by users. It allows users to select from which sponsors to receive messages. It provides a unique and customizable look and feel for each sponsor's presentation, while maintaining a common functionality of the value component.

The user interface is a portal, known as a value portal, which is implemented in a client software which executes on a user's computer system. The value portal is an elongated space on a user's desktop which comprises a message viewing area, functional buttons for launching application programs and network links, and an ornamental appearance. The client software is intended for use on computer systems with an operating system which presents a graphical user interface (GUI) through which the user interacts with the computer, such as Microsoft Windows, Linux, Apple OS, Solaris and the like. The users computer system should have access to an appropriate network, such as the Internet, where marketing will be carried out, though it is not necessary for the user to be connected to the network in order to use the client software.

When the client software launches, it installs the value portal on the user's computer system. The value portal occupies an elongated strip occupying one and preferably two lines on the operating system GUI or the GUI of an application program and comprises a message viewing area, functional buttons for launching application programs and network links, and ornamental features. The preferable position for installing the value portal is overlaying the operating system task bar, preferably at the bottom of the GUI desktop. This location has been determined to be the optimal focus of a user's attention. An alternative is just adjacent to the operating system task bar, just above the task bar in the case of a task bar at the bottom of the GUI. Still another alternative involves the client software first launching a ubiquitous application program such as a personal information manager and positioning the value portal thereon.

The value portal provides the user with access to valuable additional software applications and network links through buttons and is functional whether or not the user is connected to the network, though the network links will only be functional when the user is connected to the network. The additional software applications include applications such as office software, preferably comprising word processing, spreadsheet applications, and presentation applications, a personal information manager, e-mail application, multi-media player, and the like which are likely to be used routinely by the users and promote reliance of the user on the applications. Access to the additional software applications is preferably limited to access through the value portal, to promote regular use of the value portal. In the preferred architecture for the client software, the additional software applications are offered as precompiled Active-X programs that the client software can call and pass appropriate functionality. The client software maintains registry entries to identify the location of installed software and components that have been installed. A preferable feature of the client software is to launch new applications from the value portal so as to coordinate the position of items on the desktop, such that when successive applications are launched, the applications resize so as to dock with each other rather than to launch a new application overlapping or covering another existing application. A major purpose of the additional software and the useful features is to provide value to the user, and reliance on the value portal in day to day use of the computer thus promoting frequent and willing use of the value portal.

A value portal consists of variable and invariant features. The value portal has a look and feel which includes variable features which are determined by a group of customization parameters. The variable features comprise appearance features such as color and designs, and certain links to network sites which are relevant to the presentation of a particular sponsor or of interest to a class of users. There are preferably other invariant links which are not changed by changes in the customization parameters. The additional software applications are also not changed in functionality by changes to the customization parameters. It should be noted that the appearance of the software applications can be customized without changing the function, such as adding a logo or the like. Therefore a value portal includes variable features which depend on the customization parameters and invariant features which are invariant to changes in customization parameters. Each group of customization factors which defines a unique look and feel is known a “skin” and is registered to a single sponsor during an enrollment process.

The client software further comprises a system database capable of holding a plurality of groups of customization parameters, each corresponding to a different look and feel of the value portal. The client software comprises functionality to make it capable of identifying which skin is currently displayed on the value portal and which skins have customization parameters present in the system database. The variable features associated with a look and feel serve to promote unity or brand loyalty with the users which have installed the skin and the sponsor associated with a look and feel skin.

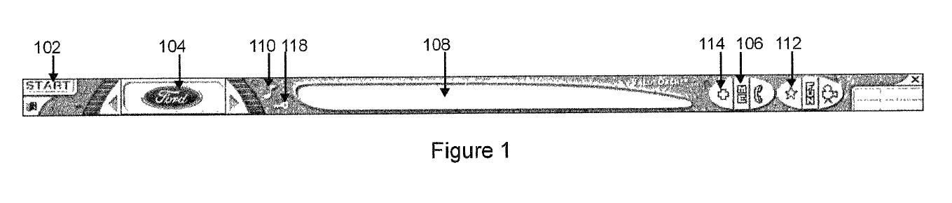

FIG. 1, is a drawing of a value portal 100, for a Windows™ GUI where the value portal overlays the Windows taskbar, showing a START button 102 from which programs are launched, a link button 104 to a variable ornamental design in the form of a trademark which links to a sponsor's desired network site, a launch button 106 which opens an invariant program a Personal Information Manager, a viewing area 108, a launch button to an invariant software feature 110 which is a multi-media player, another launch button 112 which opens up a choice of office suite software features which are invariant features comprising a word processor and the like, a button 114 which opens up a menu to various network sites which are variable sites which depend on the customization parameters, and to other variant and invariant programs. The key 118 allows each value portal skin and the files and data associated with it to be password protected.

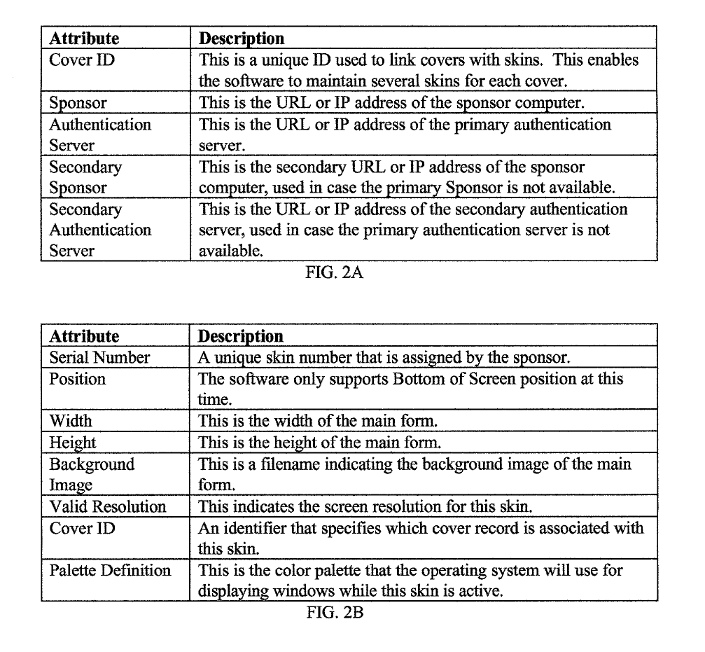

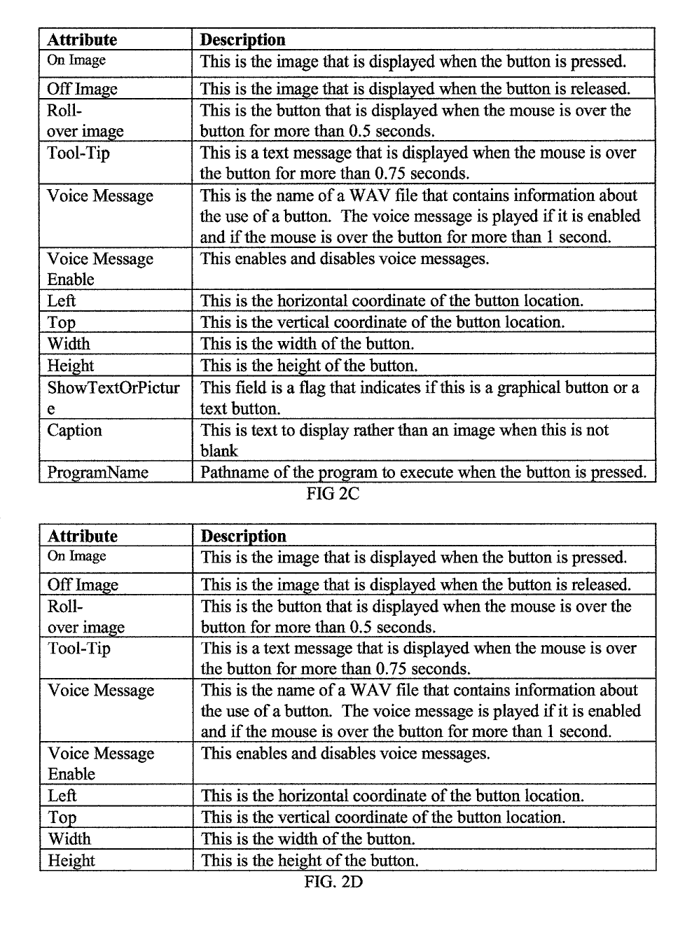

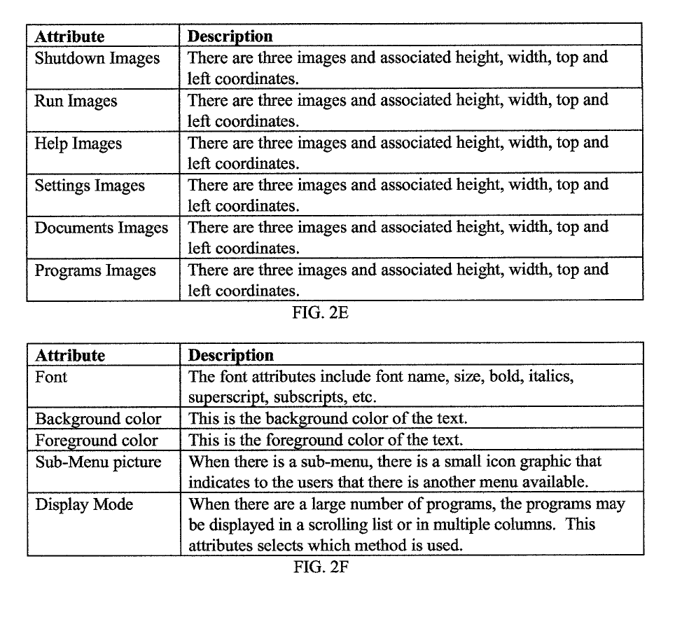

FIGS. 2A to 2F are tables showing the customization parameters that define skins. The look and feel of the program is defined by a “skin” which is specified by a set of customization parameters. A “cover” is a list of parameters that associates one or more skins to a sponsor. FIG. 2A is the cover header, containing a Cover ID, which is a unique ID used to link covers with skins and provide network addresses to the sponsor. Multiple skins may be associated with each cover. FIG. 2B is the skin header for each skin, the skin header has a unique serial number and each skin is associated with a Cover ID. FIG. 2C contains button definitions for a button. There can be any number of buttons for a skin. FIG. 2D is start button definition. FIG. 2E is a table of Start Menu Images. The Start Menu images are the images which are displayed when the START button is pressed and the menu pops up. The menu displays (top to bottom) the following choices: Programs, Documents, Settings, Help, Run, and Shutdown. These menu options have an image when the menu is displayed, a second image when the mouse moves over the menu option, and a third image when the button is pressed over the image. FIG. 2F is a table of Program Menu Options. When the user selects the program menu, the computer displays the programs that are loaded on the computer with an associated icon. The menu is hierarchical so that the programs can be put into folders or groups. The options available are shown on the table.

The client software further comprises functionality which provides a user's computer with the ability to communicate with at least one sponsor server operating a sponsor server software according to a special communications protocol, to send and receive messages from the sponsor server, and to display messages received on the viewing area of the value portal. The communication that is provided between the client software and at least one sponsor server according to the special communications protocol preferably also includes the ability to check and update the client software and update the system database, and preferably to authenticate the user to the message server and to receive authentication of the message server. A sponsor may communicate through more than one server and more than one sponsor may communicate through one server. In the preferred embodiment, the client software provides the capability to cycle through the sponsors for which a skin is installed on the system database and to choose a subset of sponsors with which to communicate, according to user preference. Preferably the client software, special communications protocol, and server software enable a first user to send and receive messages to a second user though a sponsor server which both users access as described above, such as by an “instant messaging” application which enable two users who are on line at the same time to communicate.

The client software provides the value component which is provided to users in exchange for their attention. The structure of the client software is particularly suited for performing its role. After a user installs the client program customized for the first sponsor, it is only necessary to add additional groups of customization parameters to a user's system database to make value portals available on a user's computer which are customized with the unique skins of different sponsors. Also it is only necessary to change the parameters within a particular group of customization parameters to change an existing skin. The system employing the invention thus provides a carefully controlled “mass customization” which allows users to have a comfortable common value portal interface on their desktop which is capable of providing a unique and individually customized look and feel to a wide variety of sponsors.

The sponsors communicate with users by sponsor servers using sponsor server software operating on a server. A system according to the invention is based on a client-server architecture where the client is responsible for state and data management, as well as the user interface. The sponsor server software implements the sponsor side of the special communications protocol. The main objective of the sponsor server software is to provide updates of various data types to the client, in a robust scaleable fashion. It allows the sponsor to synchronize messages, database information and software with its installed client base. It also contains functionality for adding and deleting users. The sponsor software preferably also comprises functionality for creating value portal designs for distribution in computer readable media.

The Sponsor Server may be a single computer running the Sponsor Server Software or a cluster of two or more machines fulfilling all or part of a server's functionality (e.g. database cluster, www cluster, etc.) to improve reliability and performance in a manner well known to those skilled in the art.

In the preferred embodiment, the cornerstone assumptions are as follows for a sponsor server:

1. A single server is able to handle 50,000 users simultaneously.

2. The process and data flows are segmented in such a way that each function can be handled by different server.

3. The overall architecture can be scaled to handle millions of users simultaneously.

4. Downtime can be minimized (99.99% up time).

5. Backups and other maintenance is handled in such a way that operation for the server is not affected.

6. The Sponsor Server Software is the only software installed on the Sponsor server other than the operating system and its supporting components and third party software needed to support the Sponsor Server Software.

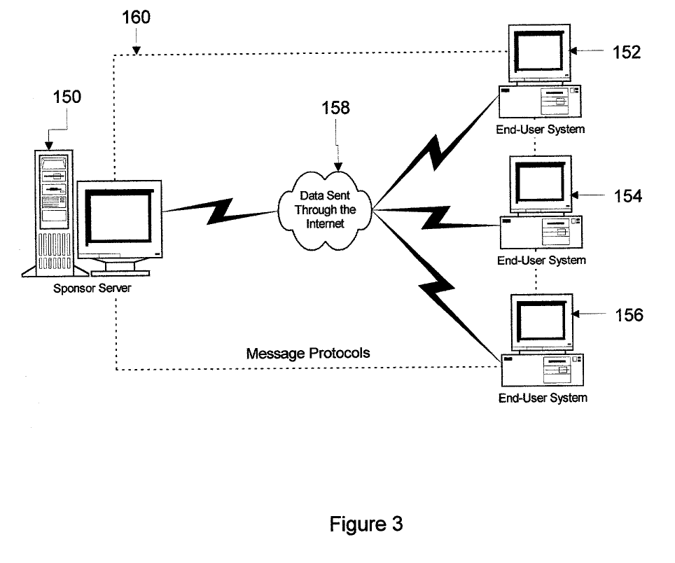

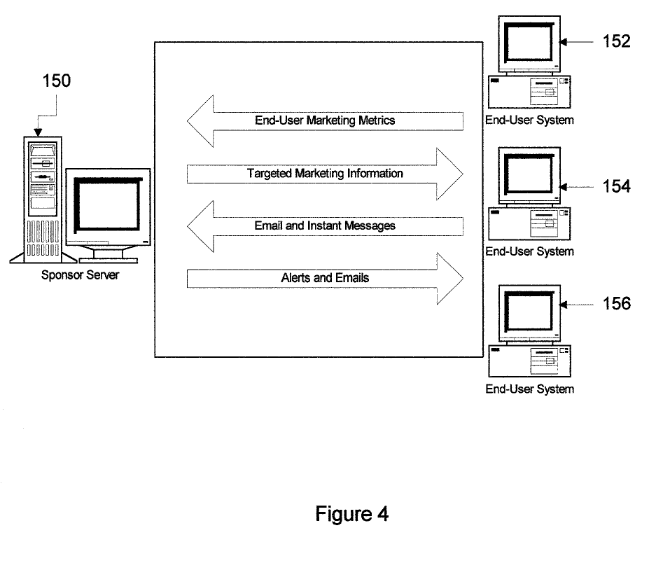

FIG. 3 is a diagram which shows the interaction of a Sponsor Server 150 executing Sponsor Server Software communicating with a plurality of users computers 152, 154, and 156 executing the client software over the Internet 158 by way of the special message protocol 160 implemented in the client software and Sponsor Server Software. FIG. 4 shows the types of exchanges between a Sponsor Server 150 and users 152, 154, and 156.

The preferred embodiment of a system implementing the system comprises a plurality of users with computers operated by the client software and a plurality of Sponsor Servers operated by the Sponsor server software both accessing through the computer network, preferably the Internet. In such a system, authentication of the interacting parties is necessary to protect the integrity of the system. Authentication provides several benefits, including:

1. authorization for access to proprietary information,

2. authentication of any node that is part of the value portal system,

3. distributed directory services for nodes,

4. tiered approach to software updates, and

5. authentication of customization parameters to be downloaded to a user's computer.

The preferred approach is for all nodes to start Internet sessions by communicating with a central authentication server, herein named “authserv”, provided by a supervising entity. This is true for both Sponsor servers and user machines running the Client Software. The central authentication server operates under an authentication server software which communicates with client systems operating the Client Software and Sponsor Servers operating the Sponsor Server Software. Sponsor Servers may be implemented as a cluster of servers for performance and reliability as will be well known to those skilled in the art.

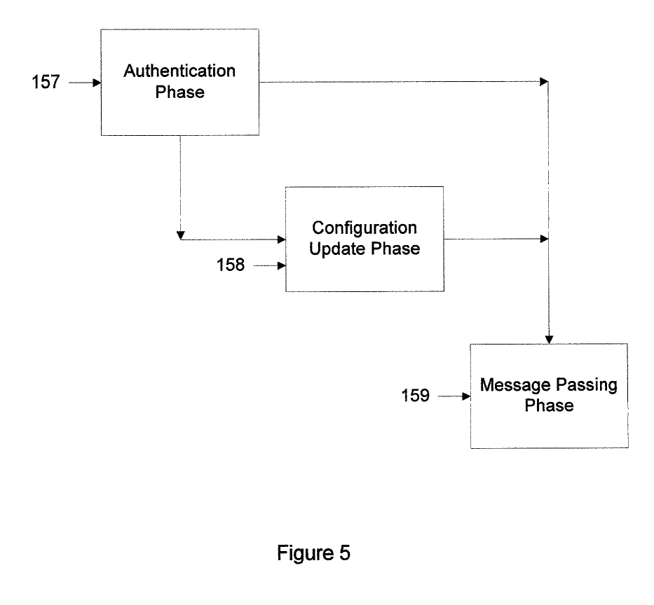

An essential part of a system implementing the invention is a special communications protocol for communication between the Sponsor Servers operating the Sponsor Server Software and the user computers operating Client Software and preferably the authentication server. The major functions to be accomplished are authentication, configuration update, and message passing. FIG. 5 is a flow diagram of the communication sequence in the preferred embodiment, showing that the configuration phase is optional and the message passing phase can be initiated without the configuration update phase.

Methods of Using the Invention

One preferred embodiment of the invention is a method for providing a system for communicating directed promotional materials among a plurality of sponsors and a plurality of users over a computer network, preferably the Internet.

The preferred method comprises the following steps carried out by a managing entity or other party if indicated:

1. Enrolling at least one and preferably a plurality of sponsors. Enrolling a sponsor comprises assigning the sponsor one or more unique groups of customization factors for defining one or more value portal skins which are relevant for that sponsor according to a standard format that can be entered into the system database which is part of the Client Software. Preferably, a sponsor is provided with software which is part of the Sponsor Software for designing value portal skins and producing Client Software on a computer readable medium for distributing a version of the Client Software which will install on a user's computer system with a system database comprising the sponsor's one or more skins.

2. Providing at least one sponsor and preferably a plurality of sponsors with Sponsor Server Software in computer readable form and encourage them to install the software and establish at least one Sponsor Server on a computer network, preferably the Internet. One sponsor may use one or more Sponsor Servers, and more than one sponsor may communicate through a single server. Each group of customization parameters defining a skin will have an associated server address to contact.

3. Providing at least one central authentication server operating the authentication software on each computer network which will be used by users and sponsors.

4. Making available copies of the Client Software to a plurality of users and encouraging them to install the software on their computer which is network accessible. The preferred way for the managing entity to make copies of the Client Software available is distribution of the Client Software by the sponsors in the form of a CD or other computer readable medium comprising the Client Software in a form which is capable of installing on a user's computer with at least one skin enabled by at least one group of customization parameters. Other means of distribution are possible such as making the software available as a download on a world wide web site. Customization factors defining value portal skins may be distributed independently from the software. For instance once a user has the software, the user is able to add additional skins corresponding to the original sponsor or different sponsors. An attractive option for distributing new skins to users is for the managing entity to establish and maintain a web site making skins of new sponsors available. When a skin is installed, either in the original installation or later there is an enrollment procedure where the user is identified to the sponsor corresponding to the skin. If an enrollment has not been completed this is prompted when the Client Software tries to access the particular sponsor for the first time.

Once a system is in place comprising at least one Sponsor Server, an authentication server, a plurality of user's computers, use of the system comprises the following actions:

1. Sponsors' back end processes queue up messages for users. The messages may comprise a title or header which the user may click to read a background message or reach a network link.

2. Users are provided with maximum flexibility in configuration of the Client Software. Preferably users are able to choose which sponsor's skins are installed, which skin is currently displayed, and whose messages to accept (including sponsors' messages and other users' messages). A user is also preferably enabled to set such parameters as how often to pick up messages when the user is on line or off line.

3. The Client Software cycles through the various sponsors which have been chosen by the user for receipt of messages. This is done by the user's computer under control of the Client Software periodically contacting the network address corresponding to the sponsor and downloading messages and updates to the software according to the special communications software. Preferably the sponsor's back end software maintains a message stack of the type where the most recent messages are kept and older messages are discarded and replaced, though those skilled in the art will recognize alternative methods of managing messages in particular assuring that urgent messages are retained.

4. The Client Software causes the message headers to be displayed for the user's perusal. The user may read the entire message, and optionally respond as with a request for more information. Alternatively, a user may be directed to a world wide web site. The Client Software preferably maintains control of messages stored in a database on the user's computer and discards message according to age and priority.

5. The message protocol allows a Sponsor Server to check the content of the customization parameters installed on a user's computer during each communication. Sponsors have the capability of updating the parameters, including the variable links to network sites of interest so that they are maintained up to date.

6. The message protocol allows a Sponsor Server to check the version of the invariant Client Software, including the additional utilitarian software and network links. The client software can be upgraded during any communication. One preferred way to accomplish this is for the managing entity to distribute updated software to the Sponsor Servers or alternatively for the Managing entity to operate a Sponsor Server.

7. Users may message other users through a common Sponsor Server using a mail or instant messaging application which is preferably part of the Client Software.

Once the system is operating, each user (through the user's computer) becomes a node on a personalized dynamically variable virtual network comprising the user, the authentication server, the Sponsor Servers corresponding to the choice of sponsors manifested by the skins which are installed on the system database and chosen for communication, and the other users who communicate with any of the same sponsors. This dynamically variable virtual network is a unique marketing structure for implementation of permissive interactive marketing for that user, since the users create the network themselves by their particular choice of sponsors and are joined by a unique group of other users with at least one similar interest.

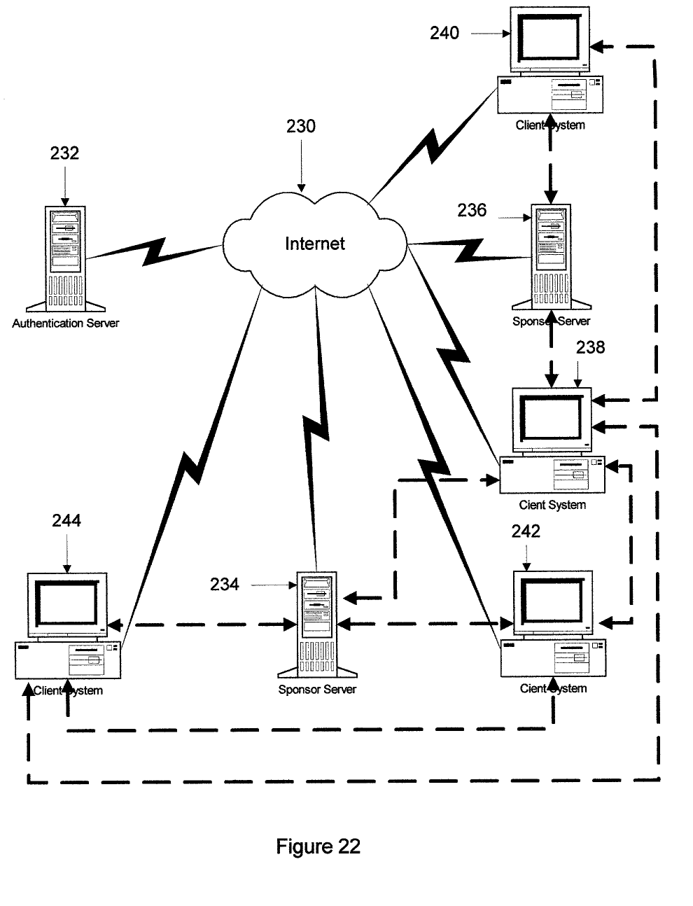

An example of a dynamically variable virtual network is illustrated in FIG. 22. FIG. 22 is a simplified network comprising one Authentication Server 232, two Sponsor Servers 234 and 236, and four client systems 238, 240, 242 and 244. On FIG. 22, all of the dashed lines are virtual connections based on the client software, sponsor software, and authentication software communicating with the special communications protocol. All of the client systems and Sponsor Systems have virtual connections with the Authentication System for mutual authentication. These are not shown in FIG. 22 for clarity. Client system 238 has chosen to affiliate with Sponsors 234 and 236. Client 240 has chosen to affiliate with Sponsor 236. Client 242 and 244 have chosen to affiliate with Sponsor 234. Therefore the virtual network of Client System 238 comprises Authentication Server 232, Sponsor Servers 234 and 236, and client systems 242, 240, and 244. The virtual network of client system 240 comprises Authentication Server 232, Sponsor Server 236, and client system 238. The virtual network of client system 242 comprises the Authentication Server 232, Sponsor Server 234 and client systems 238 and 244. Finally, the virtual network of client system 244 comprises Authentication Server 232, Sponsor Server 234, client system 242, and client system 238. It should be noted that FIG. 22 is illustrative only and a more typical situation will comprise a great number of clients for each sponsor system.

Technical Description of the Components

Client Software

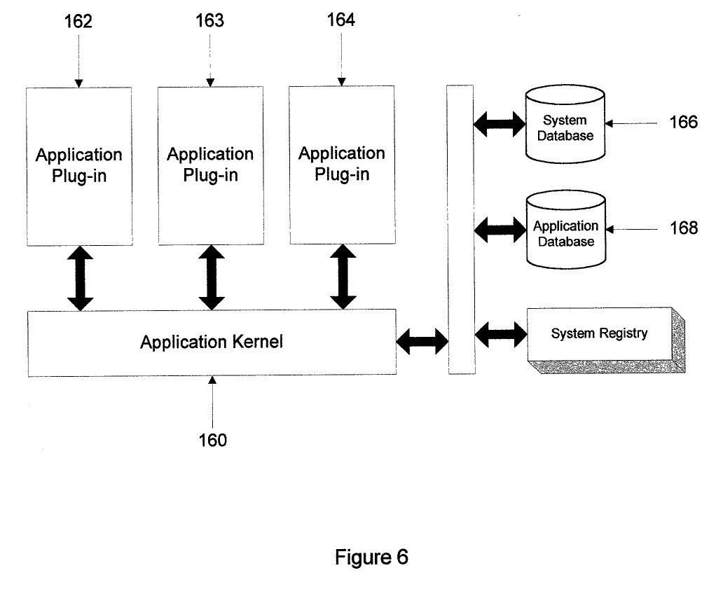

FIG. 6 is a drawing showing the relationship of the Client Software components in a preferred embodiment. An application Kernel 160 comprises the main program. The Kernel communicates with the Application Plug Ins 162, 163, and 164. The Application Plug Ins are preferably precompiled Active-X (for the Windows operating system) executable applications having a defined interface with the Application Kernel. There can be any number of Application Plug Ins which comprise the additional utilitarian software, such as PIM, e-mail, media player, instant messaging and the like. The Kernel will have registry entries to identify the location of installed software.

A system database 166 comprises system and user configured parameters and values, such as customization parameters for skins, user list and passwords, alerts parameters, e-mailbox configuration, and the like. An Application database 168 comprises tables for the applications. The Application Kernel will have a defined interface with the application database, the system database, and the system registry.

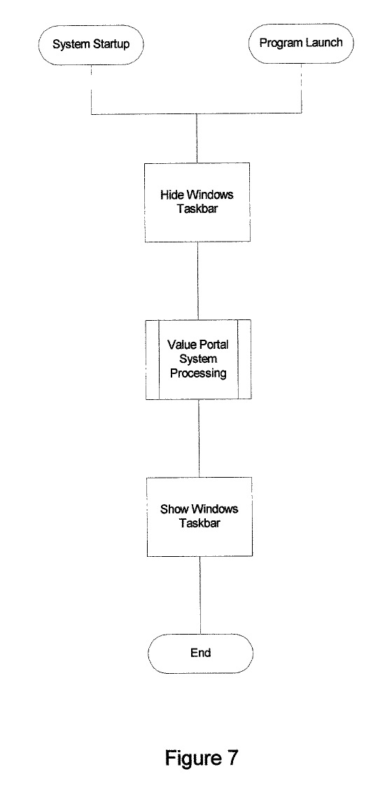

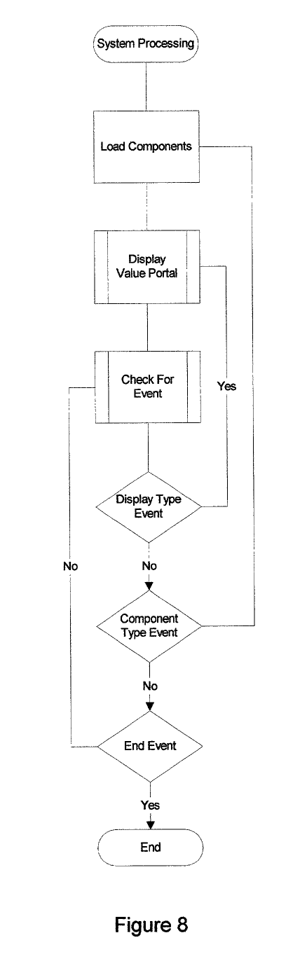

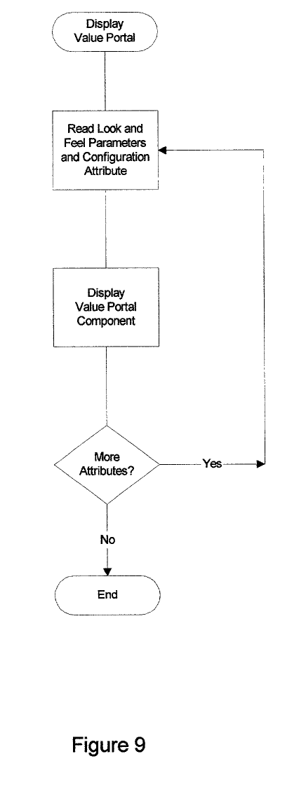

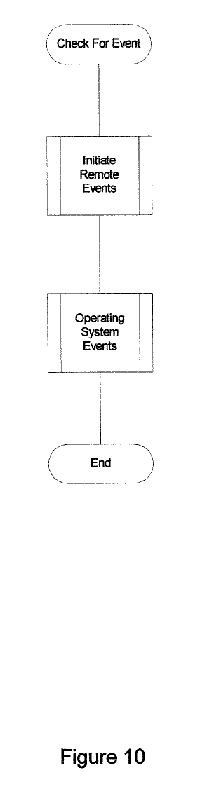

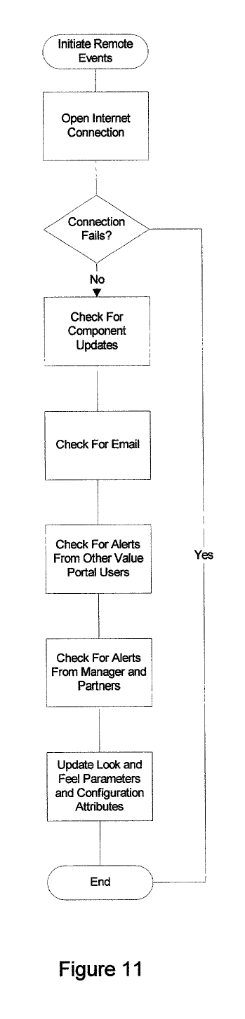

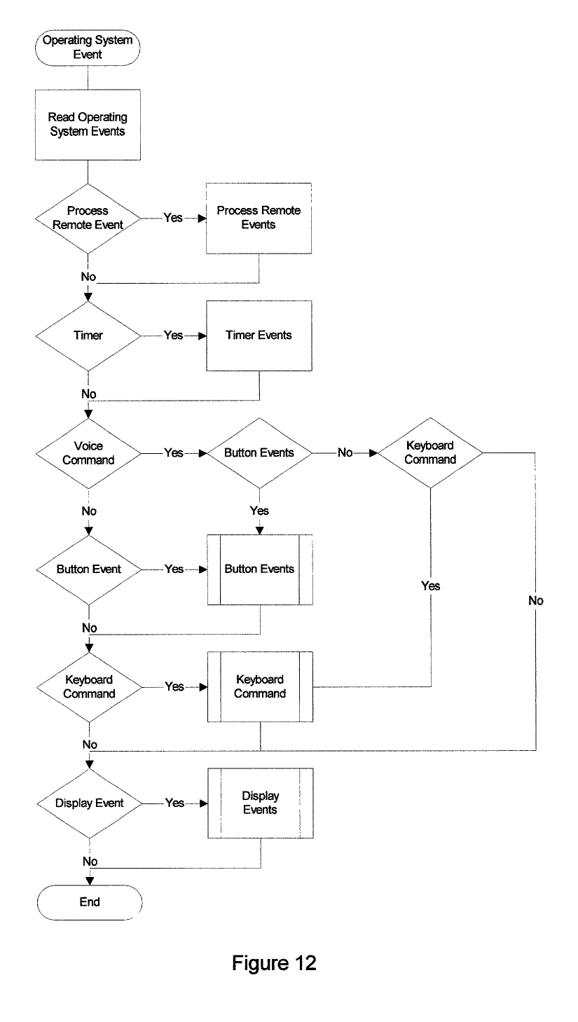

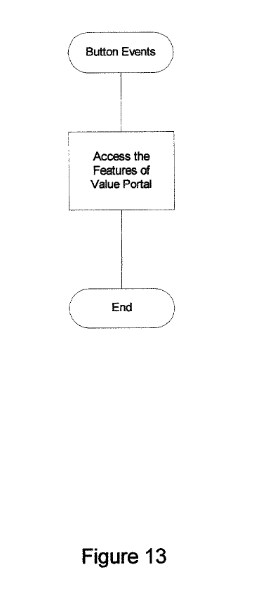

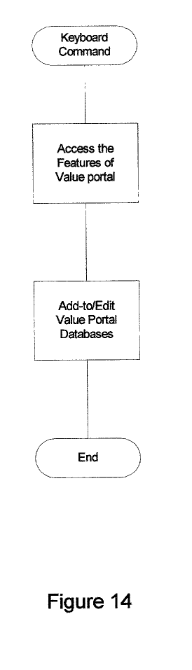

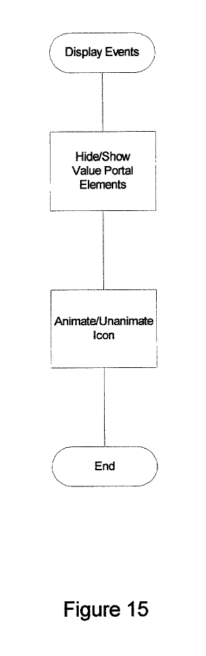

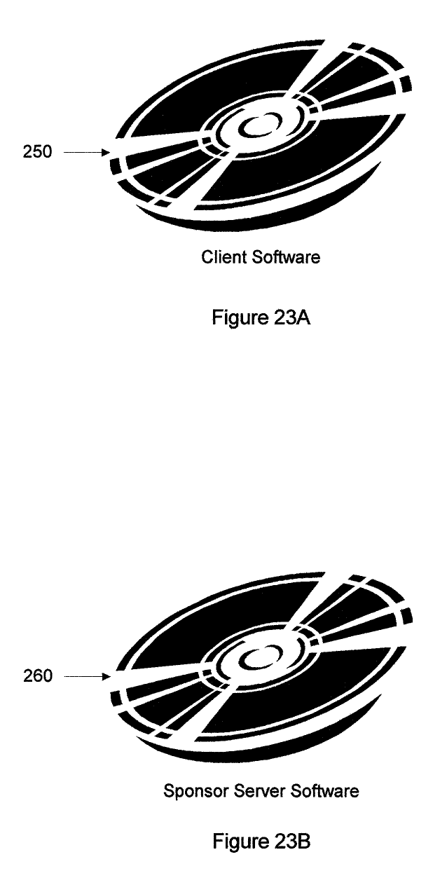

FIG. 7 shows a high level flow chart of the Client Software logic. Shown here is the preferred embodiment where the Windows operating system is task bar is overlaid by the value portal. The Windows taskbar is hidden 180, control passed to the system processing block 182 which maintains control until the program is closed, and the task bar is restored 184. FIG. 8 is a flow diagram of the system processing block 180. Software components are loaded the beginning of the program 182 and as needed in a component event 190. The default value dash skin is loaded at the beginning 184 and as needed when a user changes the skin 188. The program stands by for operating system or remote events 186. FIG. 9 shows the logic of system processing handling of display events, comprising reading look and feel and configuration parameters pertaining to a skin 190 and displaying the skin 192. FIG. 10 shows the system processing for checking for an event, which may either be a remote event 194 or an operating system event 196. FIG. 11 shows initiating remote events, comprising initiating an Internet communication according to the message protocol 198, comprising checking for component updates 200, check for email messages 202, check for alerts from other users 204, check for alerts from sponsors, update look and feel and configuration attributes 206. FIG. 12 shows handling of operating system events, comprising processing remote events 208, timer events 210, voice commands 212, button events 214, keyboard commands 216, and display events 218. FIG. 13 shows processing button events which access value portal features 220. FIG. 14 shows processing keyboard commands to access value portal features 220 and add to or edit databases 222. FIG. 15 shows handling of display events to hide or show value dash elements 224 or animate or de-animate an icon 226. FIG. 23A illustrates the client software in computer readable form on a CD ROM 250.

Sponsor Software

The preferred embodiments of the invention are based on a client-server architecture, where the client is responsible for state and data management, as well as user interface. The main objective of the Sponsor software (server) side is to provide updates of various data types to the client, in a robust and scalable fashion. The server software includes three (3) major components:

1. CD Creator

2. Taskbar Development Interface

3. Message Passing

The Sponsor server software implements the server side of the special message protocol. Using both off-the-shelf software components and custom programming, it allows the Sponsor to synchronize messages, database information, and software with its installed client base. Other significant functions include adding new clients, creating software images for media distribution, and performing reliably under stress.

Also, a significant part of the overall architecture is to compartmentalize functionality as much as possible. Generally, the three elements this addresses are:

1. Allow segments of the code base to be moved to more robust and lower latency programming environments (compiled binaries).

2. Moving functionality to other servers. The latency between servers affects how far away you can move functionality, but the plan is to move FTP and database operations to other servers, allowing a 2nd level of scalability to the architecture.

3. Cross platform support. Using standard APIs for database access and security allows for mission critical parts of the Sponsor software to run on other O/S and hardware platforms.

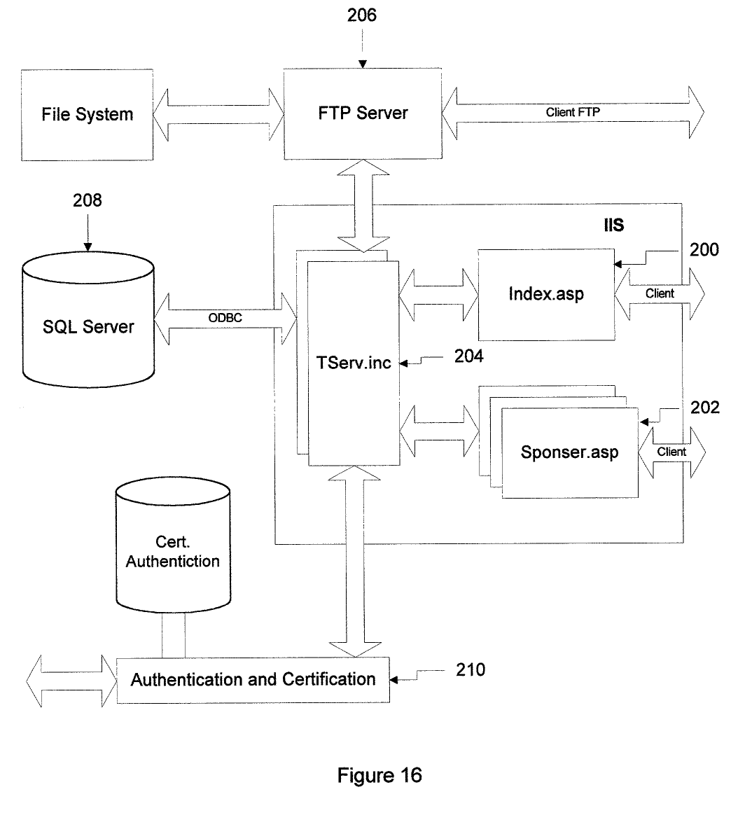

Referring to FIG. 16, the preferred implementation uses Internet Information Server (IIS), Microsoft implementation of WWW, FTP, SMTP, and NNTP server software. The core functionality can be segmented into the following:

1. Connection & Transaction Management

2. Database Interfaces & Storage

3. File Transfer & Management

4. Administration

5. Security & Authentication Systems

Referring to FIG. 16, the Server comprises:

1. ASP (Active Server Pages) pages Index.asp 200 and Sponsor.asp 202 containing server-scripts to handle inbound connections from the client. Running under IIS 5, when the scripts are requested from the client, they take control from the normal HTTP daemon for handling the request. The scripts then process the inbound connection's URL encoded data, and through a decision tree creates the response(s) to the request from the client.

2. Include files such as Tserv.inc 204 which contain functions allowing Index and Sponsor logic to read or write data to databases, ftp daemons, and authentication structures.

3. The FTP Server 206 is the second interface to client machines, with the sole purpose of moving compressed files to authorized client machines. An optional feature is to have authorization for a given user session set through functions being called in the main include files.

4. A SQL Server 208, preferably MSSQL Server 2000, used by the main include files using ODBC. The database itself contains relational and delimited structures that are used with queries and stored procedures to build responses to client requests, with the exception of binary files provided by the FTP server. The database is further documented in the section titled “Database Structures”.

5. Certification software 210 including IIS API's to third party software, such as solutions offered as ISAPI plug-ins for Windows IIS Servers and access certificate authorities.

FIG. 23B shows the sponsor server software in computer readable format on a CD ROM 260.

Database Structures

The database structures are primarily tables, stored procedures, and triggers. The tables are dependent on the format of the client side databases, both in terms of tabular data structures, field types and number of fields. It is preferred that the data structures are not mapping business processes, but simply storing information such as:

1. URL information

2. File System Paths

3. Image File Formats (Graphical Bitmap)

4. Text

5. Metadata

Given this, it is preferred to rely on procedures and functions outside of the database to enforce data integrity and normalization. This avoids the complications involved with relational structures, penalties from formatting data inside the database, and the overhead typically placed on database development and code.

The tables themselves can be viewed in three separate categories: index information, data for replication to the client side, and security.

The index tables contain information about packages and associated metadata for those packages. It is through the index tables that the information is provided to the client for the client to decide what packages and updates it needs. The index tables are structured for speed, with no relationships or joins needed for responding to client requests about whether an update is needed. These tables are also static in nature, only changing when packages are added or modified, and as such, advanced MSSQL Server techniques such as bitmapping can be used to speed up replies to queries.

The tables that contain data to be replicated to clients are also to be tabular data structures, as the data being handled by the database does not exhibit any of the classic features of data that should be put into relational format. As with the index tables, the Sponsor tables are structured for speed in queries.

The security tables are dynamic data stored for the purpose of authenticating users & client connections, recording user sessions, transactions in the databases that need to be exported on a cyclical basis, and other features that are core to the maintenance of the database itself. These tables are actually the most important in terms of backups and helping us to debug processes.

Of note is that multiple Sponsors may run on a single server, but for security purposes, it is preferred that there are separate SQL databases for each Sponsor.

Depending on the client-server architecture, stored procedures can fulfill many different functions. In the case of the Sponsor software, stored procedures, along with triggers, are mainly be used for database maintenance. In some cases though, the stored procedures may be created and used for interfaces to outside systems that do not have ODBC connectivity, or in situations where ODBC does not support the functionality needed. While stored procedures are efficient, it adds another level of complexity to the database, and the procedures themselves almost never port to other SQL implementations. It is preferred that any and all stored procedures be implemented outside of the database using code that can be easily ported to other platforms and implementations of SQL.

The major cornerstone assumptions and requirements for software are as follows:

1. A single server is able to handle 50,000 users simultaneously.

2. The process & data flows are segmented in such a way that each function can be handled by a different server

3. The overall architecture can be scaled to handle millions of users simultaneously

4. Down time for a server is minimized (99.99% up time)

5. Backups and other maintenance are handled in such a way that operation for the server is not affected

6. The Sponsor Server Software is the only software installed on the server, other than the O/S and its supporting components, and third party software that is used to support the Sponsor Server Software.

Special Message Protocol

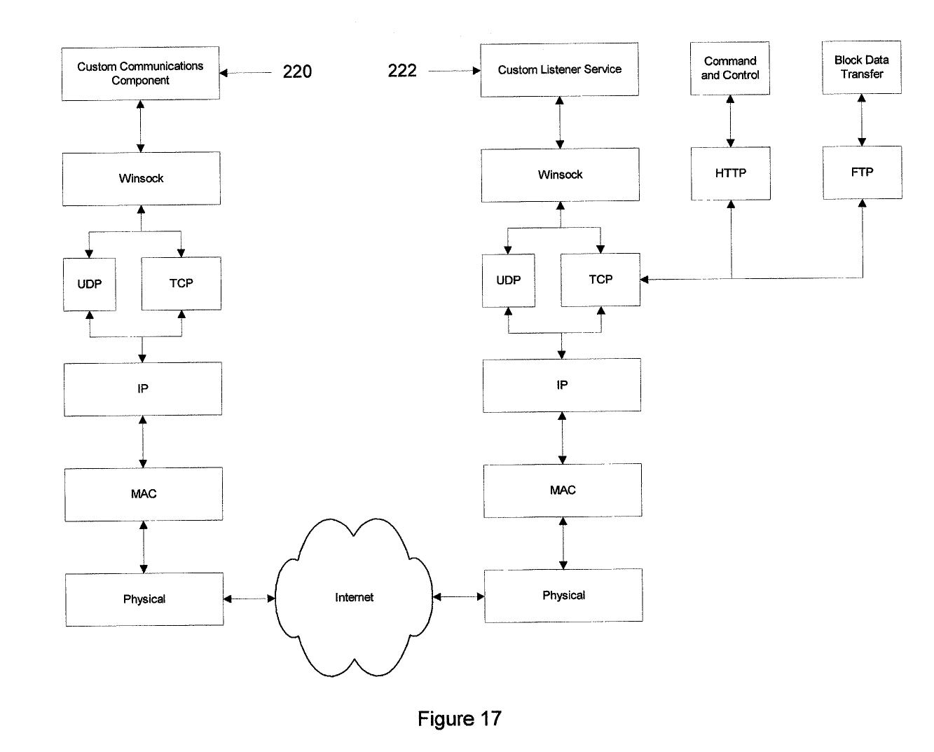

The special communications protocol is the protocol for communications between the Client systems (user computers operating the Client Software) and Sponsor Servers and is implemented in software in the Client Software and the Sponsor server software. Referring to FIG. 17, the preferred protocol is a layered protocol with a Custom Communications Component 220 on the client system and a Custom Listener Service 222 on the Sponsor Server side. The low-level layers are typically implemented using TCP/IP. Other low-level protocols such as IrDA are also supported.

The special communications protocol is preferably a “stop and wait” protocol initiated by the client. When a message is sent, the sender waits for a response before sending another command.

All messages according to the preferred embodiment have the following general format: Length (2 bytes)-Client ID (4 bytes)-Type (1 Byte)-Data (n bytes). The least significant byte is preferably transmitted first.

The Length field indicates the total length of the message in bytes. This length includes all of the fields within the message: Length, Client ID, Type, Data, and CRC. The length field is provided as a means to easily determine the location of the CRC. Thus the message integrity can be verified prior to the examination of the message content, including the message type.

The Client ID field is not used for CHANNEL_REQUEST and NEW_USER_INFO messages and their responses, because a Client ID has not been assigned (see below). However, these messages contain authentication data. The authentication data is much longer in length than the Client ID. Once a user has been created and a channel has been assigned, the Sponsor's Listening Service will assign a Client ID. This Client ID will only be recognized by the Transfer Agent which the Sponsor created on the specified port. Once the client closes the connection to the Transfer Agent the Client ID will no longer be valid. Likewise, if the Transfer Agent does not receive any messages from the client within the specified timeout period, the Transfer Agent will stop executing and the Client ID will become invalid.

The Type field of a message indicates to the recipient of the message the type of data that is in the Message Data field of the message. Messages Types are defined in the table below. The direction (D) column in the table indicates the direction. All messages to the sponsor are called command messages and are indicated with a C. All responses that are returned from the sponsor to the client are called response messages and are indicated with an R.

Message Type Field

| | | |
|---|---|---|
| Message Type | D | Summary Description |
| ACK | R | Response to all properly handled requests that do not return |
| | | data. |
| NAK | R | Response to all messages that cannot be handled. |
| CHANNEL_REQUEST | C | Request for an available port and Client ID |
| CHANNEL_ASSIGNED | R | Response to a CHANNEL_REQUEST containing a Client ID that |
| | | is being assigned to the client. This response is used for return |
| | | users. |
| NEED_NEWUSER_INFO | R | Response to a CHANNEL_REQUEST for a first time user. |
| | | This indicates that a channel will not be assigned until a new |
| | | user account is created. |
| NEW_USER_INFO | C | Request to create a new user account. |
| NEW_USER_CREATED | R | Response to a NEW_USER_INFO message when a new user |
| | | account has just been created. |
| OPEN | C | Request to open a new connection. |
| CLOSE | C | Request to close a connection. |
| CHECK_USR_MSGS | C | Request for the number of user messages waiting to be delivered. |
| MSGS_AVAILABLE | R | Specifies the number of user messages that the Sponsor is |
| | | holding for the client. |
| FETCH_NEXT_USR_MSG | C | Request to the sponsor that the next waiting user message be |
| | | forwarded to the client. |
| RCVD_USR_MSG | R | A user message that was received from another client. This is |
| | | a response to FETCH_NEXT_MESSAGE. |
| SEND_USR_MSG | C | A user message that is to be sent to another client. |
| ENUM_NEW_COMPONENTS | C | Request for all components newer than the specified date/time. |
| NEW_COMPONENTS | R | Specifies the number, type, and ID of all components that are |
| | | newer than the specified date/time. |
| CHECK_VERSION | C | Request for the version of a component. |
| COMPONENT_VERSION | R | Specifies the version for the request component. |
| GET_FILE | C | Request a ifie. |
| FILE_START | R | Specifies information that is related to the file, but that is not part of |
| | | the file. (e.g. file size, number of FILE_DATA records to expect, |
| | | and CRC) This is returned in response to GET_FILE before any |
| | | FILE_DATA is sent. |
| FILE_DATA | R | Part of the data for the requested file. |
| GET_DB_TABLE | C | Request for the format of a new or modified table. |
| DB_TABLE | R | Specifies the format of the requested table. |
| GET_DB_DATA | C | Request for any new data for the specified table. |
| DB_START | R | Specifies information that is related to the database data that will be |
| | | sent. This includes the number of records from the specified table |
| | | that will be sent and the number of DB_DATA records to expect. |
| DB_DATA | R | Part of the data for the database. |

Authentication

A necessary part of the architecture of the preferred embodiment (Sponsor & Client) is authentication.

The basic approach is for all nodes to start Internet sessions by communicating with a central authentication server (authserv) provided by a managing entity. This is true for both Sponsor Servers and client machines on the Internet, but the architecture is flexible enough that if a connection cannot be made to the authentication server, that clients and Sponsor servers can still connect and synchronize.

The data exchanged in any given authentication session falls into the following table:

| | |
|---|---|
| ClientID | Unique identifier for a client machine. Created by |
| | authentication servers only. |
| ServerID | Unique identifier for any server node on the client server |
| | network |
| SponsorID | Identifier for Sponsors |
| SessionID | Unique identifier for a given session |
| UpdateAddress | IP addresses that are returned from directory services that |
| | are part of the authentication mechanism, comma |
| | delimited for multiple addresses |

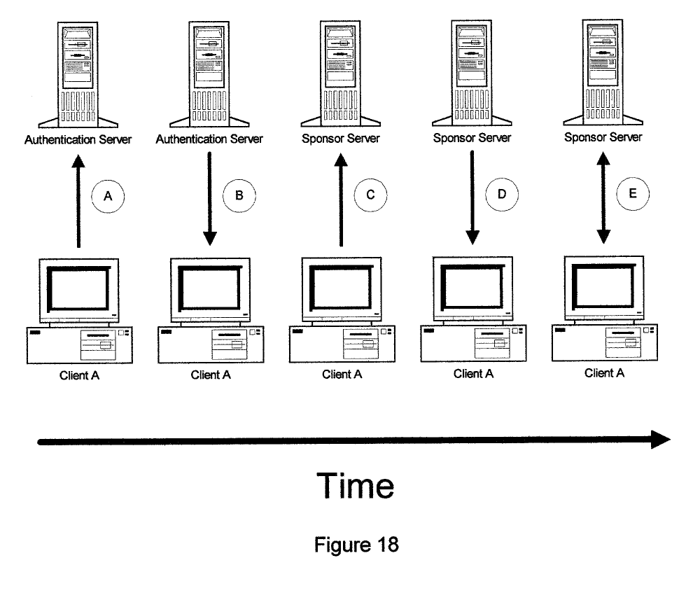

The architecture contemplates four models, illustrated on FIGS. 18, 19, 20 and 21. FIG. 18 illustrates the typical authentication model.

a) The client establishes a connection to the authserv. In the initial request, the clientID (if established) and SponsorID are included. If the clientID is not available (for any reason), the authserv issues a new one. If the SponsorID is validated by the authserv, the client is considered authenticated.

b) Based on the SponsorID and the clientID, a sessionID is passed back to the client. At this point, the client checks the sessionID against a hash table, and if it passes, the client has authenticated the authserv. Also passed back from the authserv is the address of the Sponsor server that the client should communicate with for updates and synchronizing.

c) Using UpdateAddress, the client connects to the Sponsor server, and passes the sessionID from the authserv and the clientID.

d) The Sponsor server hashes the sessionID and the clientID, and passes back a new sessionID. The Sponsor server has now authenticated the client.

e) The sessionID from the Sponsor server is validated by the client, and if it passes, the Sponsor server is now authenticated to the client. The sessionID is used for any further transactions between the client and the Sponsor server.

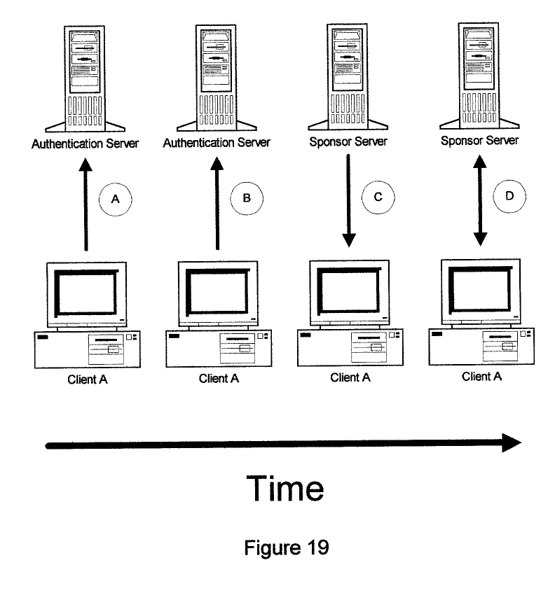

FIG. 19 is the procedure if the authentication server is not available.

a) The client establishes a connection to the authserv. The authserv is not available.

b) The client establishes a connection to the Sponsor server. In the initial request, the clientID (if established) and SponsorID are included. If the clientID is not available (for any reason), the Sponsor server issues a new temporary one. The client is considered authenticated.

c) Based on the SponsorID and the clientID, a sessionID is passed back to the client. At this point, the client checks the sessionID against a hash table, and if it passes, the client has authenticated the Sponsor server.

d) The sessionID is used for any further transactions between the client and the Sponsor server.

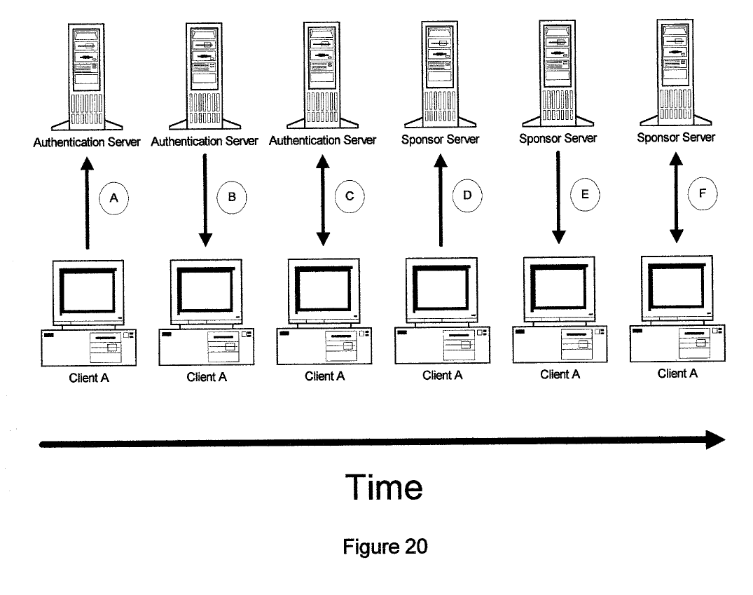

FIG. 20 is the procedure when multiple updates are required.

a) The client establishes a connection to the authserv. In the initial request, the clientID (if established) and SponsorID are included. If the clientID is not available (for any reason), the authserv issues a new one. If the SponsorID is validated by the authserv, the client is considered authenticated.

b) Based on the SponsorID and the clientID, a sessionID is passed back to the client. At this point, the client checks the sessionID against a hash table, and if it passes, the client has authenticated the authserv. Also passed back from the authserv is the address of the Sponsor server that the client should communicate with for updates and synchronizing.

c) Using the first address in UpdateAddress, the client re-connects to the authserv, and passes the sessionID and the clientID. From here synchronizing of data, and software transactions happen between the authserv and the client.

d) Using nth address in UpdateAddress, the client connects to the Sponsor server, and passes the sessionID from the authserv and the clientID.

e) The Sponsor server hashes the sessionID and the clientID, and passes back a new sessionID. The Sponsor server has now authenticated the client.

The sessionID from the Sponsor server is validated by the client, and if it passes, the Sponsor server is now authenticated to the client. The sessionID is used for any further transactions between the client and the Sponsor server

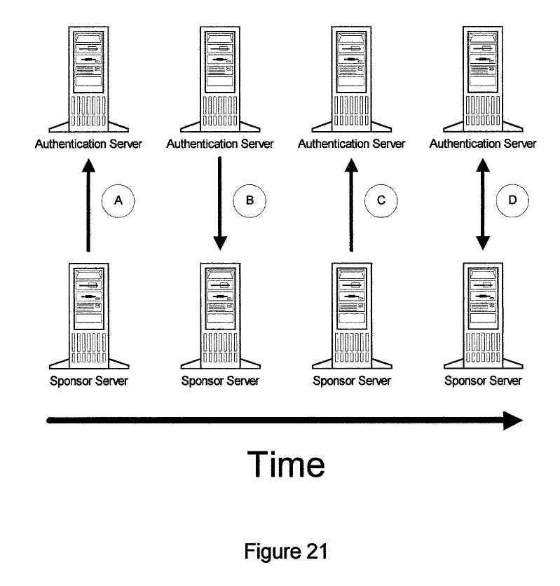

FIG. 21 is the procedure for server-server authentication.

a) The Sponsor server establishes a connection to the authserv. In the initial request, the ServerID and SponsorID are included.

b) If the ServerID and the SponsorID are validated by the authserv, the Sponsor server is considered authenticated. Based on the SponsorID and the ServerID, a sessionID is passed back to the Sponsor software.

c) At this point, the Sponsor server checks the sessionID against a hash table, and if it passes, the Sponsor server has authenticated the authserv. It then passes synchronization data back to the authserv.

d) The sessionID is used for any further transactions between the client and the Sponsor server for that session.

The invention provides methods, systems, and software for conducting permissive interactive marketing in that a user of the system is provided with valuable software to run on their computer. The software encourages the user to operate and use it and at the same time be receptive for marketing information forwarded from sponsors. Sponsors are provided with a standardized, though customizable format to present their message, which will be readily recognized by users. Users form a personalized dynamically variable virtual network of sponsors which they subscribe to by accepting their portal skins, and users in common with those sponsors, which enhances their marketing experience.

Although the present invention has been described in considerable detail with reference to certain preferred versions thereof, other versions are possible. Therefore the spirit and scope of the appended claims should not be limited to the preferred versions herein.

We claim:

1. A method of providing a system for selective communication of promotional information among a plurality of sponsors and a plurality of users over a computer network comprising the acts of:
a) enrolling a plurality of sponsors, the act of enrolling each sponsor comprising the act of assigning the sponsor with at least one group of customization parameters which are sufficient to uniquely define the look and feel of a value portal skin;
b) providing a sponsor server software in computer useable form to at least one of the plurality of sponsors, wherein the sponsor server software executing on a sponsor server comprises functionality for communicating messages with a client software on a user's computer over the computer network according to a special communication protocol;
c) providing the client software to a plurality of users in machine useable form, each of said plurality of users having a user's computer capable of using the client software and having access to the computer network, wherein each user's computer operates under an operating system having a graphical user interface with a task bar thereon, and wherein the client software when executing on a user's computer comprises
i) functionality for installing a value portal on the user's computer, the look and feel of the value portal capable of being defined by any of the unique group of customization parameters defining a value portal skin which have been assigned to each of the plurality of sponsors,
ii) functionality for providing access to a plurality of additional utilitarian application programs through said value portal,
iii) a system database capable of storing a plurality of groups of customization parameters, said system database comprising at least one group of customization parameters therein corresponding to at least one sponsor of said plurality of sponsors,
iv) functionality for choosing which group of customization parameters from the plurality of groups of customization parameters in the system database will be used to define the look and feel of the value portal,
v) functionality for exchanging messages with at least one sponsor through communication with a sponsor server operated by the sponsor server software, according to the special communication protocol,
vi) functionality for displaying messages on the value portal, and
vii) functionality for registering a user with a sponsor server executing the sponsor server software.

2. The method of claim 1 further comprising the act of providing at least one authentication server operating with an authentication server software accessible to the computer network, said authentication server being capable of authenticating a communication between one of said plurality of user's computers operating the client software and a sponsor server operating the sponsor server software communicating according to the special communication protocol.

3. The method of claim 2 wherein the plurality of additional utilitarian application programs are accessible only when the client software is operating on a user's computer, whereby regular use of the software is promoted.

4. The method of claim 3 wherein the functionality of the plurality of utilitarian application programs is invariant to which group of customization parameters defines the value port skin.

5. The method of claim 4 wherein the client software further comprises functionality for periodically accessing at least one sponsor server to obtain messages according to the special communication protocol.

6. The method of claim 5 wherein the client software further comprises functionality for optionally updating the client software program and system database on a user's computer during a communication according to the special message protocol.

7. The method of claim 6 wherein the value portal is installed overlaying the task bar on the graphical user interface.

8. The method of claim 6 wherein the value portal is installed adjacent to the task bar on the graphical user interface.

9. The method of claim 6 wherein the client software launches an application program with the value portal included thereon.

10. The method of claim 6 wherein the client software, the sponsor server software, and the special message protocol contain functionality to enable a first user to exchange a message with a second user through a common sponsor server which both the first user and the second user periodically exchange messages.

11. A client software on a computer readable medium for operation on a user's computer comprising:
a) functionality for installing a value portal on a user's computer, the look and feel of the value portal capable of being defined by a group of customization parameters defining a value portal skin which have been assigned to a sponsor;
b) functionality for providing access to a plurality of additional utilitarian application programs through said value portal;
c) a system database capable of storing a plurality of groups of customization parameters, said system database comprising at least one group of customization parameters therein corresponding to at least one sponsor;
d) functionality for choosing which group of customization parameters from the plurality of groups of customization parameters in the system database will be used to define the look and feel of the value portal;
e) functionality for exchanging messages with at least one sponsor through communication with a sponsor server operated by a sponsor server software, according to a special communication protocol;
f) functionality for displaying messages on the value portal; and
g) functionality for registering a user with a sponsor server executing the sponsor serve software, wherein the sponsor server software comprises functionality for communicating with the user's computer executing the client software when operating the sponsor server software.

12. The client software of claim 11 wherein the plurality of additional utilitarian application programs are accessible only when the client software is operating on a user's computer, whereby regular use of the software is promoted.

13. The client software of claim 12 wherein the functionality of the plurality of utilitarian application programs is invariant to which group of customization parameters defines the value portal skin.

14. The client software of claim 13 wherein the client software further comprises functionality for periodically accessing at least one sponsor server to obtain messages according to the special communication protocol.

15. The client software of claim 14 wherein the client software further comprises functionality for optionally updating the client software program and system database on a user's computer during a communication according to the special communication protocol.

16. The client software of claim 15 wherein the value portal is installed overlaying the task bar on the graphical user interface.

17. The client software of claim 15 wherein the value portal is installed adjacent to the task bar on the graphical user interface.

18. The client software of claim 15 wherein the client software launches an application program with the value portal included thereon.

19. A sponsor server software on a computer readable medium which is capable of communicating with the client software of claim 15 according to the special communications protocol.

20. A system for selective communication of promotional information among a plurality of sponsors and a plurality of users over a computer network comprising:
a) at least one sponsor server accessible over the computer network;
b) sponsor server software operating said at least one sponsor server;
c) a plurality of user's computers, having access to the computer network and operating under control of an operating system with a graphical interface having a task bar thereon;
d) client software operating each of the plurality of user's computers said client software comprising
i) functionality for installing a value portal, the look and feel of the value portal capable of being defined by a group of customization parameters defining a value portal skin which has been assigned to a sponsor,
ii) functionality for providing access to a plurality of additional utilitarian application programs through said value portal,
iii) a system database capable of storing a plurality of groups of customization parameters, said database comprising at least one group of customization parameters therein corresponding to at least one of said plurality of sponsors,
iv) functionality for choosing which group of customization parameters from the at least one group of customization parameters in the system database which will be used to define the look and feel of the value portal,
v) functionality for exchanging messages with the at least one sponsor server,
vi) functionality for displaying messages on the value portal, and
vii) functionality for registering each of the plurality of users with the at least one sponsor server; and
e) a special communication protocol by which a user's computer system operated by the client software can exchange messages with the at least one sponsor server operated by the sponsor server software, said special communication protocol implemented in software operating on the at least one sponsor server and the plurality of user's computers.

21. The system of claim 20 further comprising at least one authentication server operating with authentication server software capable of authenticating one of said plurality of user's computers to the at least one sponsor server according to the special communication protocol.

22. The system of claim 21 wherein the computer network is the Internet.

23. The system of claim 22 wherein the at least one sponsor server comprises a plurality of sponsor servers which are each operated by at least one sponsor.

24. The system of claim 23 wherein the plurality of additional utilitarian programs are accessible only when the client software program is operating, and the functionality of the plurality of utilitarian programs is invariant to selection of which group of customization parameters defines the look and feel of a value portal, whereby regular use of the client software is encouraged.

25. The system of claim 24 wherein the communications protocol further comprises functionality for updating the client software program and system database on a user's computer during a communication session with a sponsor server.

26. The system of claim 25 wherein the sponsor server software, the client software, and the special communications protocol provide functionality for a first user's computer and a second user's computer to exchange a message through a common sponsor server which both the first user and second user periodically exchange messages according to the special communications protocol.

27. The system of claim 25 wherein the value portal installed by the client software is installed overlaying the task bar on the graphical user interface.

28. The system of claim 25 wherein the value portal installed by the client software is installed adjacent to the task bar on the graphical user interface.

29. The system of claim 25 wherein the value portal installed by the client software is installed within an application program launched by the client software.

30. The personalized dynamically variable virtual network accessible to one of the plurality of user's computers in the system of claim 26 comprising the at least one authentication server, the sponsor servers with which the one user's computer exchanges messages, and the user's computers which exchange messages with the sponsor servers which the one user's computer exchanges messages.
